(19) United States
(12) Patent Application Publication
(10) Pub. No.: US 2005/0223532 A1
(43) Pub. Date: Oct. 13, 2005

(54) METHOD OF DESIGNING A VEHICLE CLOSURE ASSEMBLY LINE

(75) Inventors: Abid Ghuman, Bloomfield Hills, MI (US); Michael Czarnecki, Grosse Pointe Woods, MI (US); Brian Genord, Macomb Township, MI (US); Christopher Jent, Grosse Pointe Farms, MI (US); Daniel Quinn, Troy, MI (US); John Robertson, Troy, MI (US); David Sweet, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 10/709,045

(22) Filed: Apr. 8, 2004

(51) Int. Cl. B23Q 17/00; G01M 19/00

(52) U.S. Cl. 29/407.09; 29/430; 29/711; 29/791; 29/795

(57) ABSTRACT

A method of designing a manufacturing process line for a vehicle closure. A process is identified by specifying a set of discrete steps. A subset of steps is assigned to one of a plurality of standardized work cells. The work cells include a standardized workpiece presenter and a standardized processing tool. Additional subsets of discrete steps are assigned to a standardized work cell until the design for the manufacturing process is complete.

### BACKGROUND OF INVENTION

1. Field of the Invention

The present invention relates to a flexible system for designing a vehicle closure manufacturing line and more particularly to a method of developing a manufacturing process that standardizes the use of flexible systems used in manufacturing vehicle closures.

2. Background Art

Successful automobile manufacturing companies must be able to efficiently produce a variety of different vehicles. One way manufacturing efficiency can be realized is to make more than one vehicle model on a vehicle assembly line. Unfortunately, different vehicle models seldom utilize the same components or subassemblies. For instance, vehicle closures, such as doors, hoods, trunk lids, and hatchbacks, typically have different shapes and sizes for each vehicle model. Moreover, each door on a particular vehicle model may have a unique design.

Previously, vehicle manufacturing operations employed multiple “feeder” process lines to provide the closures needed to make a vehicle. Specifically, each vehicle closure was made on a dedicated, specialized assembly line that lacked the flexibility to make more than one closure design. Using specialized assembly lines is expensive and inefficient due to the capital investment, labor, and maintenance required to operate each feeder line.

Additional inefficiencies are incurred when multiple vehicle models are produced. Specifically, more specialized closure assembly lines are required to provide closures for the added vehicle model. Consequently, it is difficult to add assembly lines to an existing plant without affecting the layout of other assembly lines or increasing plant floor space. Moreover, the equipment used to assemble prior model closure designs is generally not reused when a new closure design is made. As a result, expensive new equipment and long changeover times are incurred when new closure designs are introduced.

### SUMMARY OF INVENTION

According to one aspect of the invention, a method of designing a manufacturing process line for making a vehicle closure is provided. A manufacturing process that includes a set of discrete steps to be performed on a workpiece and a plurality of standardized work cells are identified. The standardized work cells have at least one standardized workpiece presenter that supports the workpiece in a predefined spacial orientation and at least one standardized processing tool. A subset of the set of discrete steps to be performed at a work cell is selected. The standardized work cell is selected for performing the subset of steps. The selecting step is repeated for additional subsets of steps until all of the discrete steps are assigned to one of the plurality of work cells.

A plurality of manufacturing process lines may be identified as templates. The manufacturing process line may be completely designed by specifying a plurality of templates in a defined sequence.

A first work cell may be pedestal welding work cell having a robotic arm for picking up and moving workpieces from a fixture to a processing tool selected from the group consisting essentially of a pedestal welder, a sealer dispensing unit, and a projection weld gun. A second work cell may be a multiple sided trunnion fixture having a plurality of fixtures rotatable about a horizontal axis and a processing tool selected from the group consisting essentially of a welding robot, and a sealant applicator. A third work cell may be a hem clinch station having a fixture and a processing tool selected from the group consisting essentially of a hemming tool, a clinching tool, and a piercing tool.

The closure may be a vehicle passenger compartment door, a vehicle trunk lid, a vehicle hatchback, or a vehicle engine compartment hood.

According to another aspect of the invention, a manufacturing process line for making a vehicle closure is provided. The manufacturing process line includes a first template having a plurality of work cells. The work cells include a pedestal welding work cell and a trunnion work cell. The plurality of work cells are arranged in a predetermined sequence such that at least one trunnion work cell is disposed between consecutive pedestal welding work cells.

The manufacturing process line may include three pedestal welding work cells and four trunnion work cells. The first, third, and sixth work cells may be pedestal welding work cells and the second, fourth, fifth, and seventh work cells may be trunnion work cells. The manufacturing process line may also include a material handling robot for transporting parts between the second work cell and the third work cell.

The manufacturing process line may include a second template having a plurality of work cells arranged in a predetermined sequence. The second template may include a pedestal welding work cell, a trunnion work cell, and a hem clinch work cell. The second template may receive the workpiece from the first template and perform additional operations on the workpiece to complete fabrication of the closure.

The second template may include one pedestal welding work cell, one trunnion work cell, and two hem clinch work cells. The first cell may be a trunnion work cell. The second work cell may be a pedestal welding work cell. The third and fourth work cells may be hem clinch work cells. The first work cell may be configured with a sealant dispensing unit as the processing tool. A material handling robot may be provided for transporting the workpiece from the second work cell to the third work cell and from the third work cell to the fourth work cell.

### BRIEF DESCRIPTION OF DRAWINGS

FIG. 1 is a flowchart of a method of designing a closure assembly manufacturing system according to the present invention;

FIGS. 2-5 are perspective views of standardized work cells that are arranged following templates that are combined to create a complete closure assembly manufacturing system;

FIG. 6 is a flowchart of a vehicle manufacturing system made up of templates having standardized work cells;

FIG. 7 is an exploded view of a vehicle closure; and

FIGS. 8-9 are templates for making a vehicle closure.

### DETAILED DESCRIPTION

Vehicle closures are panel-like assemblies that are movably attached to a vehicle body and are configured to cover one or more body openings when disposed in a closed position. Vehicle closures include doors, hoods, trunk lids, hatchbacks, and other components.

Vehicle closure manufacturing systems are generally configured as assembly or process lines. The process line produces a closure assembly from a plurality of subassemblies that are generated from various combinations of workpieces. The process line is comprised of a plurality of standardized work cells or task stations. To enjoy the greatest benefit from the present invention, the number of different task stations is limited.

Each task station in a given process line has a workpiece presenter and a processing tool. The workpiece presenter may include a selectively moveable platform. A fixture plate may be precisely located on the platform to position workpieces in a repeatable manner.

The process can in some instances position two separate workpieces and weld them together using a welding robot. In other configurations, a fixture holds just one workpiece for welding or other various metal working operations. For example, these operations can include spot welding or weld finishing operations. In still other operations, a fixture or a robot positions a workpiece or subassembly for sealant or adhesive application operations.

A set of work cells are defined and combined in what is referred to as a template. A combination of at least two or more templates are organized in a predetermined manner to form a process line on which the complete closure assembly is fabricated.

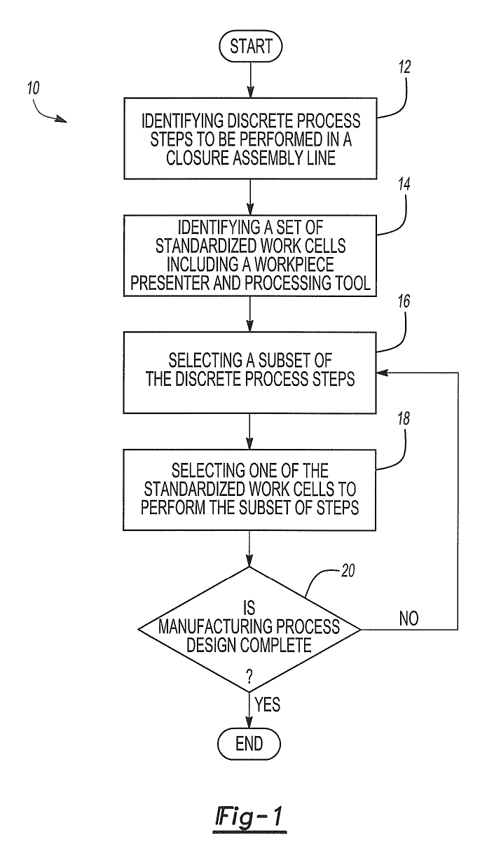

Referring to FIG. 1, a manufacturing engineering design process for designing a process line is illustrated by a flowchart. According to the process, the first step is identifying, at 12, discrete process steps that are to be performed in a manufacturing process line. Next, at 14, a set of standardized work cells are identified including a workpiece presenter and a processing tool. At 16, the step of selecting a subset of the discrete processing steps is performed. Then selecting, at 18, one of the standardized work cells to perform the subset of steps. At 20, a decision is made as to whether or not the manufacturing process is complete. If all of the steps have not been performed, the method returns to the selecting step at 16. This may be continued until the entire manufacturing process design is completed.

A flexible manufacturing system according to the present invention preferably utilizes three standardized flexible work cells.

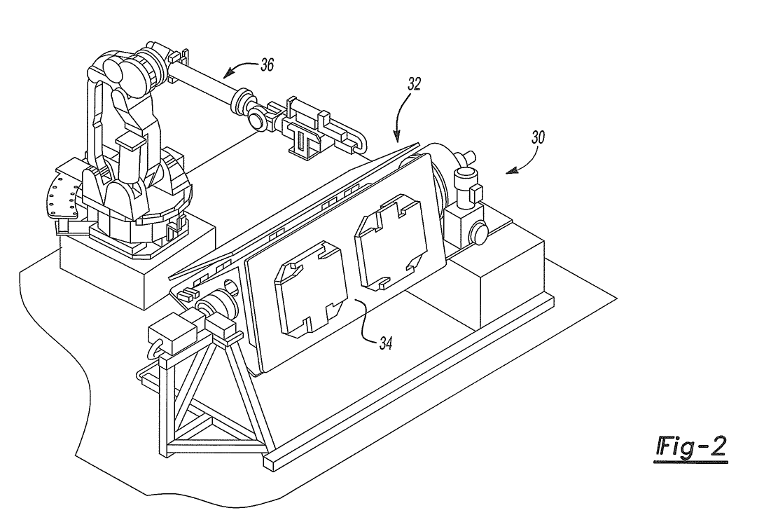

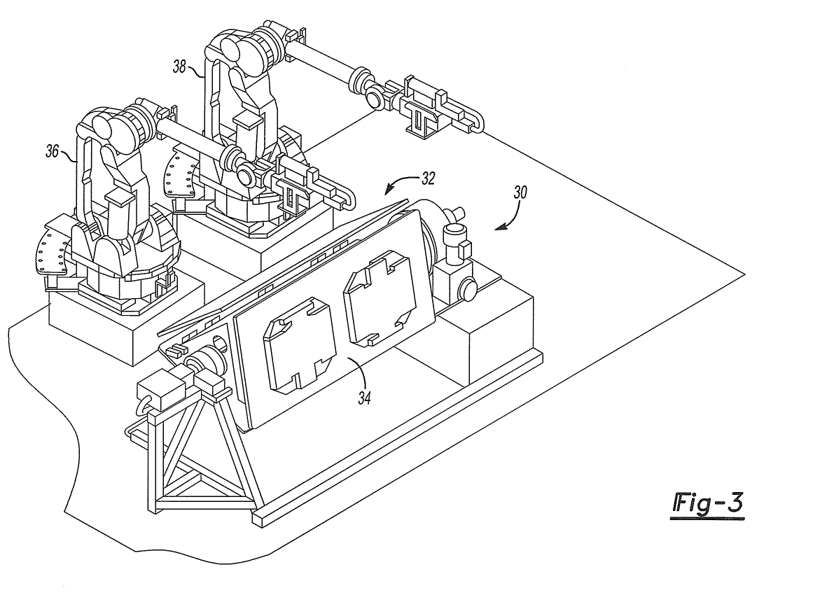

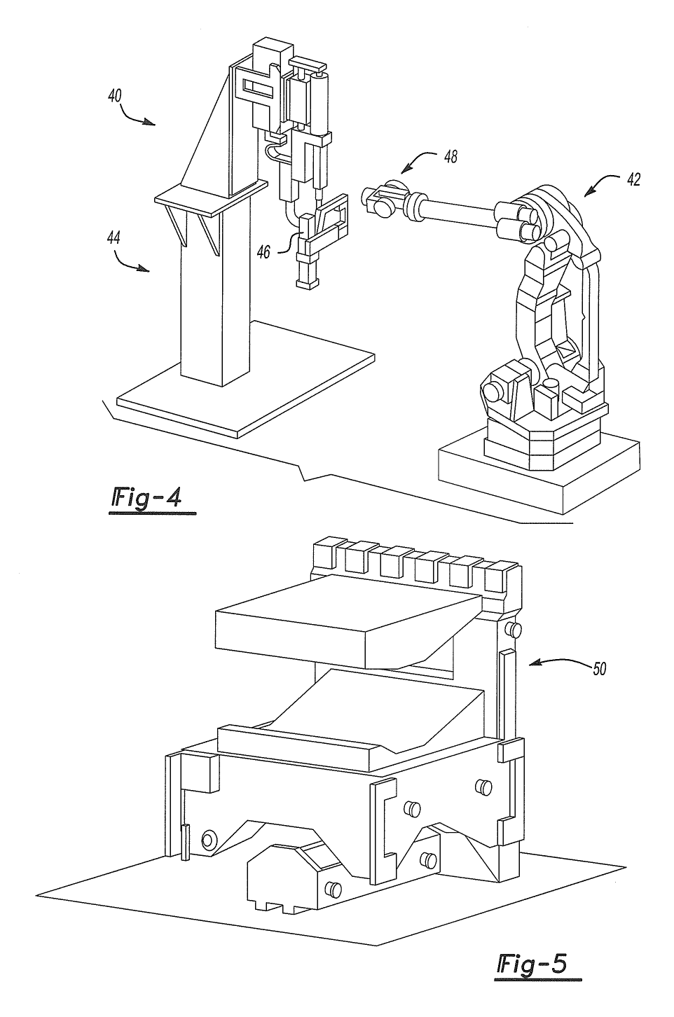

Referring to FIG. 2, work cell one is shown. Work cell one is a geometry setting work cell or trunnion station 30 that includes a trunnion fixture 32. Tooling plates 34 may be mounted on each side of the trunnion fixture 32. In the embodiment shown, the trunnion fixture is three-sided. Alternatively, a two-sided trunnion fixture may be employed. The two-sided trunnion fixture can accept a standard tooling plate that may have a larger size than the tooling plates employed with the three-sided trunnion fixture 32. The trunnion fixture 32 rotates about a horizontal axis so as to present workpieces to a robot 36. Optionally, two robots 36, 38 may be employed in work cell one, as shown in FIG. 3. The robots 36, 38 may be used to perform any suitable operation, such as a welding or sealing operation. In addition, a first robot can be used to move a workpiece and a second robot can be used to perform an operation on the workpiece. The robots 36, 38 may be completely robotic or otherwise.

Referring to FIG. 4, work cell two is shown. Work cell two is a pedestal welding work cell 40 having a pedestal welder 42 and a robot 44 for positioning a workpiece. In the embodiment shown, the pedestal welder 42 includes a welding element 46 of any suitable type or configuration. Alternatively, the welder 42 could be replaced with an adhesive dispenser or a sealer dispenser (not shown). The robot 44 has an end effector 48 comprising a gripper for grasping a workpiece or subassembly. The robot 44 positions the workpiece adjacent to the welding element 46 to execute one or more welds. For example, the robot 44 may reposition the workpiece relative to the welding element 46 to execute a plurality of welds.

Referring to FIG. 5, work cell three is shown. Work cell three is a hem clinch or pierce work cell 50 which may include either a conventional hemmer or a clincher or a pierce tool. To improve process flexibility, the hemmers can be equipped with different dies that are configured to hem door assemblies having different geometries. For example, one hemmer equipped with automated die changeover equipment can be employed to facilitate the hemming of different door assemblies. Optionally, multiple hemmers may be used, in which case each hemmer could be equipped with different dies corresponding to the hemming requirements and configuration of a particular closure. A robotic material handler (not shown) may be used with this work cell to insert and/or remove processed workpieces or subassemblies.

The flexible closure assembly manufacturing system may also include standardized transfer work cells to move workpieces and subassemblies between various templates and operational work cells.

The process line can be made flexible in different ways. Different subassemblies or closures, such as front and rear passenger compartment doors, may be manufactured on the same process line. These workpieces may be made in any sequence. For example, different closure subassemblies can be manufactured simultaneously due to the presence of workpiece presenters having tooling plates compatible with each type of subassembly. In rare instances, where the process line is dedicated to one type of closure, the entire process line can be quickly retooled by changing the appropriate tooling plates, reprogramming the robotic operators, and changing hemming dies. However, in most instances, flexibility is chiefly accomplished by having workpiece presenters with tooling plates for all types of subassemblies desired. A process line or work cell may be designed to accommodate any suitable number of tooling plates. For example, in one embodiment each trunnion may accommodate up to three tooling plates.

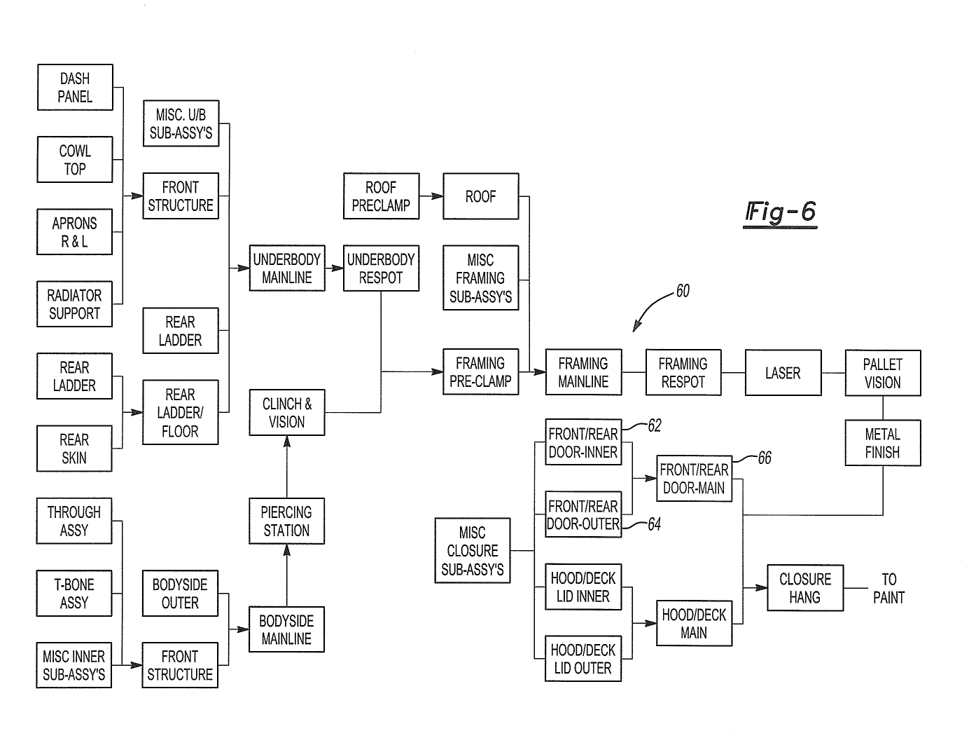

Referring to FIG. 6, an example of a flexible process line is shown. Specifically, the process line 60 is for assembling the body of a car. Similar process lines may be created for other types of vehicles, such as trucks.

The process line 60 is made up of a number of subassembly process lines or templates, represented by rectangular boxes. Three templates 62, 64, 66 related to making a passenger compartment door will be discussed in greater detail below. The arrowed lines connecting the templates represent the process flow of components or workpieces.

A set of templates utilized to make a vehicle closure will now be described. In one embodiment, the closure is a passenger compartment door in which components are joined together primarily by welding or riveting. However, the present invention can be used with any type of closure or joining technique and is not limited to a vehicle door. In each template the flow of material between work cells is represented by arrowed lines. Optionally, each template may employ one or more decoupling stations to provide a buffer between work cells to improve material flow.

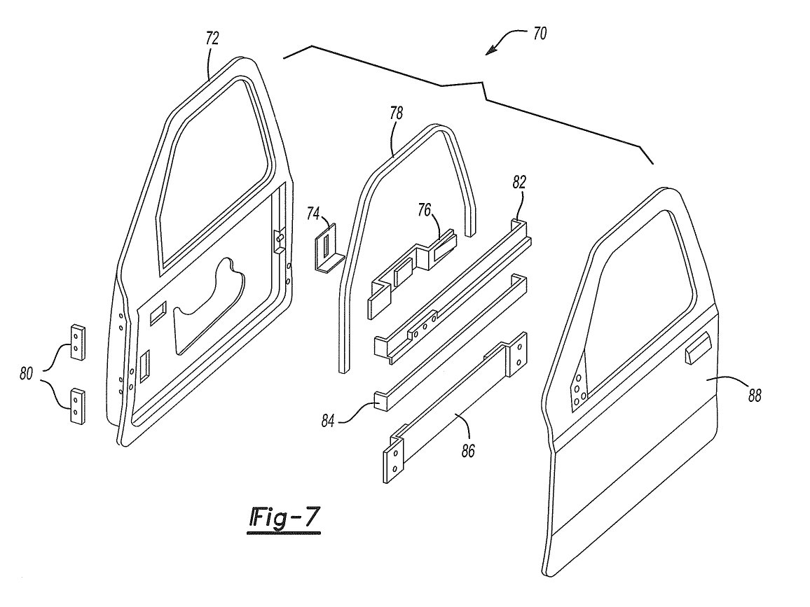

Referring to FIG. 7, an exploded view of a vehicle door assembly 70 is shown. The vehicle door assembly 70 includes an inner panel 72, latch reinforcement 74, inner belt 76, glass channel 78, tapping plates 80, outer belt 82, anti-flutter beam 84, intrusion beam 86, and outer panel 88.

Referring again to FIG. 6, the door assembly 70 is manufactured using an inner door panel template 62, an outer door panel template 64, and a main door panel template 66. More specifically, an inner door panel subassembly and an outer door panel subassembly are provided by the inner and outer door panel templates 62, 64, respectively. The inner and outer door panel subassemblies are assembled into the door assembly 70 by the main door panel template 66.

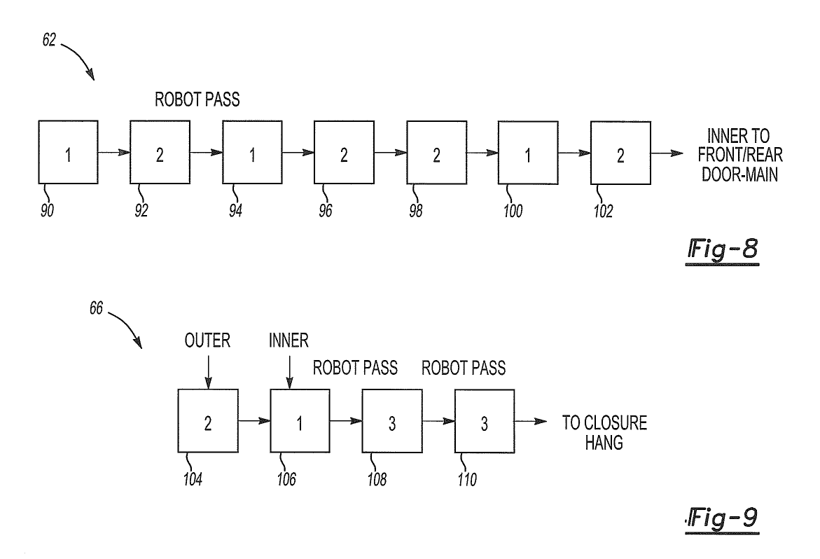

Referring to FIG. 8, the inner door panel template 62 is shown in more detail. The inner door panel template 62 includes seven work stations 90, 92, 94, 96, 98, 100, 102. More specifically, the inner door template 62 includes two trunnion stations (work cell 1, denoted “1”) and four pedestal welding work cells (work cell 2, denoted “2”). This template could also be used to make another type of closure, such as a complete trunk lid or hood.

At 90, the inner panel 72, latch reinforcement 74, and inner belt 76 are loaded onto the three-sided trunnion fixture 32. The fixture positions these components for attachment at a specific positions. The robot executes multiple welds to attach the latch reinforcement 74 and inner belt 76 to the inner panel 72.

At 92, spot welds are performed to better secure the latch reinforcement 74 and inner belt 76 to the inner panel 72. A material handling robot (denoted “robot pass”) may be used to transport the inner panel subassembly to the next work cell.

At 94, the glass channel 78 and two tapping plates 80 are loaded onto the three-sided trunnion fixture. Next, a robot executes multiple geometry setting welds to attach the glass channel 78 and tapping plates 80 to the inner panel subassembly.

At 96 and 98, additional welds are performed to better secure the glass channel 78 and tapping plates 80 to the inner panel subassembly.

At 100, the outer belt 82, anti-flutter beam 84, and intrusion beam 86 are loaded onto the three-sided trunnion fixture. Next, a robot executes multiple geometry-setting welds to attach the outer belt 82, anti-flutter beam 84, and intrusion beam 86 to the inner panel subassembly.

At 102, additional welds are performed to better secure the outer belt 82, anti-flutter beam 84, and intrusion beam 86 to the inner panel subassembly.

Referring to FIG. 9, the main door panel template 66 is shown. The main door template 66 includes four work stations 104, 106, 108, 110. More specifically, the main door panel template 66 includes one trunnion station (work cell 1, denoted “1”), one sealant dispensing work cell (work cell 2, denoted “2”), and two hem clinch stations (work cell 3, denoted “3”).

At 104, the outer panel 88 may be grasped by a robot and moved to a sealant dispenser. The sealant dispenser then dispenses drops or a bead of a sealer, such as mastic, along an inside surface of outer panel 88 configured to contact the inner panel subassembly.

At 106, the inner panel subassembly is mated to the outer panel 88 to create an unfinished door assembly. More specifically, the inner panel may be placed on the outer panel or vice versa. The inner panel subassembly may be transferred to the main door assembly line 66 using a material handling robot. A material handling robot may be used to transport the door assembly to the next work cell.

At 108, the perimeter of the door assembly is hemmed. More specifically, the outside perimeter of the outer door 88 is hemmed to the inner door 72 to provide structural rigidity. A material handling robot may be used to transport the door assembly to the next work cell.

At 110, the inner window opening edges of the door panel assembly are hemmed. Optionally, a single hemming work cell could be employed to perform all hemming operations.

After 110, the door panel assembly may be unloaded and undergo subsequent operations, such as inspection and/or sealant curing, before being transferred to a closure hanging operation as shown in FIG. 6.

While the best mode for carrying out the invention has been described in detail, those familiar with the art to which this invention relates will recognize various alternative designs and embodiments for practicing the invention as defined by the following claims.

1. A method of designing a manufacturing process line for a vehicle closure, the method comprising:
identifying a manufacturing process comprising a set of discrete steps to be performed on at least one workpiece;
identifying a plurality of standardized work cells, each work cell having at least one standardized workpiece presenter that supports a workpiece in a predefined spacial orientation, and at least one standardized processing tool;
selecting a subset of the set of discrete steps to be performed at a work cell and selecting the standardized work cell for performing the subset of steps; and
repeating the selecting step for additional subsets of steps to be performed at one of the plurality of work cells until all of the discrete steps are assigned to one of the plurality of work cells.

2. The method of claim 1 wherein a plurality of manufacturing process lines are identified as templates.

3. The method of claim 2 wherein the manufacturing process line is completely designed by specifying a plurality of templates in a defined sequence.

4. The method of claim 1 wherein the workpiece presenter and processing tool are interrelated with an integrated standard control system.

5. The method of claim 1 wherein a first work cell comprises the standardized workpiece presenter comprising a pedestal welding work cell having a robotic arm for picking up and moving workpieces from a fixture to the processing tool selected from the group consisting essentially of a pedestal welder, a sealant dispensing unit, and a projection weld gun.

6. The method of claim 5 wherein a second work cell comprises the standardized workpiece presenter comprising a multiple sided trunnion fixture having a plurality of fixtures for a plurality of workpieces that are rotated about a horizontal axis and the processing tool is selected from the group consisting essentially of a welding robot and a sealant applicator.

7. The method of claim 6 wherein a third work cell comprises the standardized workpiece presenter comprising a fixture in a tool and the processing tool is selected from the group consisting essentially of a hemming tool, a clinching tool, and a piercing tool.

8. The method of claim 1 wherein the closure is a vehicle passenger compartment door.

9. The method of claim 1 wherein the closure is a vehicle trunk lid.

10. The method of claim 1 wherein the closure is a vehicle hatchback.

11. The method of claim 1 wherein the closure is a vehicle engine compartment hood.

12. A manufacturing process line for making a vehicle closure, the manufacturing process line comprising:
a first template having a plurality of work cells including: a pedestal welding work cell having a robotic arm for picking up and moving a workpiece to a processing tool selected from the group consisting essentially of a pedestal welder, a sealant dispensing unit, and a projection weld gun; and
a trunnion work cell having a multiple sided trunnion fixture that is rotated about a horizontal axis to position the workpiece near a second processing tool selected from the group consisting essentially of a welding robot and a sealant applicator;
wherein the plurality of work cells are arranged in a predetermined sequence such that at least one trunnion work cell is disposed between consecutive pedestal welding work cells.

13. The manufacturing process line of claim 12 comprising three pedestal welding work cells and four trunnion work cells.

14. The manufacturing process line of claim 13 wherein the first, third, and sixth work cells are pedestal welding work cells and the second, fourth, fifth, and seventh work cells are trunnion work cells.

15. The manufacturing process line of claim 14 further comprising a material handling robot for transporting workpieces between the second work cell and the third work cell.

16. The manufacturing process line of claim 12 further comprising a second template having a plurality of work cells arranged in a predetermined sequence, the work cells including:
a pedestal welding work cell;
a trunnion work cell; and
a hem clinch work cell including a fixture and a processing tool, the processing tool selected from the group consisting essentially of a hemming tool, a clinching tool, and a piercing tool;
wherein the second template receives the workpiece from the first template and performs additional operations on the workpiece to complete fabrication of the closure.

17. The manufacturing process line of claim 16 comprising one pedestal welding work cell, one trunnion work cell, and two hem clinch work cells.

18. The manufacturing process line of claim 17 wherein a first work cell is a trunnion work cell, a second work cell is a pedestal welding work cell, and third and fourth work cells are hem clinch work cells.

19. The manufacturing process line of claim 18 wherein the first work cell is configured with a sealant dispensing unit as the processing tool.

20. The manufacturing process line of claim 16 further comprising a material handling robot for transporting the workpiece from the second work cell to the third work cell and from the third work cell to the fourth work cell.
